(19) United States
(12) Patent Application Publication
(10) Pub. No.: US 2011/0028129 A1
(43) Pub. Date: Feb. 3, 2011

(54) Proximity Triggered Profile-Based Wireless Matching

(76) Inventors: James W. Hutchison, Chicago, IL (US); Mitchell A. Carrel, Chicago, IL (US); Robert Matles, Glenview, IL (US); Christine A. Hutchison, Chicago, IL (US); Lauren R. Matles, Glenview, IL (US); Lee M. Whitman, Raleigh, NC (US); Lisa A. Brinkman, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/578,363

(22) Filed: Oct. 13, 2009

(51) Int. Cl. H04M 3/42; H04B 7/00

(52) U.S. Cl. 455/414.1; 455/41.3

(57) ABSTRACT

A match-making system allows users possessing mobile communications devices such as cell phones and/or PDAs to be alerted to the proximity of other users that may be a romantic, professional or other “match” to the user of interest based on a comparison of profile properties. The system may operate via a near-field radio-frequency system such as Bluetooth or a cellular or other relatively far-field wireless system, or a combination of the two in a complimentary manner. The disclosed system also allows a connection between the users to be made if desired by both users, and otherwise allows one or the other user to decline a connection. Matching by the system may be used for social or business purposes.

### TECHNICAL FIELD

This disclosure relates generally to systems and methods for proximity-based matching of individuals and, more particularly, to a system and method for locating matches for a user based on both the real-time proximity of candidate matches and the degree to which a currently proximal candidate match conforms to one or more predetermined criteria.

### BACKGROUND

With the advent and spread of the Internet, and in particular of internet-based dating services and options, it is fairly easy for users to identify others who are compatible for purposes of dating, sharing hobbies, discussing viewpoints, or having other grounds for affinity. Such services provide a mechanism for potentially compatible users to become known to one another and to become further acquainted.

However, all such services that are currently in existence are more or less static, in that they lack the spontaneity and real-time dynamics of a more direct mode of meeting. Couples who meet spontaneously at bars, restaurants, sporting events, etc., are generally more satisfied and excited by the initial interaction with their partners. Even so, there are hurdles and draw backs to such in-person meeting opportunities. For example, in the context of seeking a potential dating partner, bashful individuals may have difficulty approaching desirable partners who are not yet personally known to them. Moreover, for shy and outgoing individuals alike, the fear of rejection in a face-to-face conversation prevents many people from approaching a desirable partner who may, in actuality, have welcomed the attention.

While it would be ideal if potential suitors were indifferent to rejection and discomfort, the reality is that potential matches, whether for business or personal purposes, will continue to miss each other absent an effective system for breaching the aforementioned barriers. To this end, the inventors have created a new and useful mechanism for leveraging the prevalence of personal communication devices to facilitate real-time match-making.

When considering this background section, the disclosure and claims herein should not be limited by the deficiencies of the prior art. In other words, the solution of those deficiencies, while desirable, is not a critical limitation of any claim except where otherwise expressly noted in that claim. Moreover, while this background section is presented as a convenience to the reader who may not be of skill in this art, it will be appreciated that this section is too brief to attempt to accurately and completely survey the prior art. The preceding background description is thus a simplified and anecdotal narrative and is not intended to replace printed references in the art. To the extent an inconsistency or omission between the demonstrated state of the printed art and the foregoing narrative exists, the foregoing narrative is not intended to cure such inconsistency or omission. Rather, applicants would defer to the demonstrated state of the printed art.

### SUMMARY

In an embodiment of the invention, a system is provided wherein users possessing mobile communications devices such as cell phones or PDAs are alerted to the physical proximity (e.g., within 100 meters) of other users that may be a “match” to the user of interest based on a comparison of profile properties. The system may operate via a near-field radio-frequency system such as Bluetooth or a cellular or other relatively far-field wireless system. In an embodiment of the invention, both near-field and far-field technologies are used in a complimentary manner to identify proximal users and detect a match.

User location information is provided via GPS in an embodiment of the invention. Many cell phones and other handheld communications devices are equipped with GPS functionality in order to provide navigation or other services etc., and the invention is able to leverage this in-place functionality to detect proximity. Alternatively, the availability of near-field connectivity serves as an indicator of proximity.

In one example, the system matches users based on dating compatibility, as determined from preset user profiles. Every user is not only looking for matches, but is also being considered by others as a potential match. Thus, in an embodiment of the invention, each user profile is comprised of two portions, namely a user-descriptive portion and a match-descriptive portion. The user-descriptive portion of the user profile is utilized by the system to convey information about the user to another proximal user so that the other proximal user's communication device may assess the potential for a match. The match-descriptive portion of the user profile contains criteria used to evaluate potential matches. Such criteria may include, for example, age, interests, religion, education level, income range, interest in parenting, and other personal attributes and inclinations. In an embodiment of the invention, certain characteristics may be weighted more heavily than others.

Once a currently proximal user satisfying a certain number or percentage of the preset criteria of a first user is identified at the mobile device of the first user, the first user receives a real-time electronic notification, via e-mail, text message or similar medium, that another user or users meeting their criteria are nearby. The first user, upon receiving the notification, may then be provided the option of reviewing additional information pertaining to the potential match (the proximal user) to decide whether an immediate face-to-face meeting is desired. If so, a notification is sent from the device of the first user to the device of the proximal user to request a connection.

At the device of the proximal user, a similar process then occurs. In particular, the proximal user is given the opportunity to view information relating to the first user and to decide whether or not to accept the connection request from the first user. If the request is accepted, the first and proximal users are placed into direct electronic communication. At this point, the users may have a substantive conversation electronically or may simply agree on a meeting location to physically meet one another and have a face-to-face conversation. Such a meeting is greatly eased by the fact that the users are already close to one another (e.g., within 100 meters).

In a further embodiment of the invention, third-party sponsorship opportunities are provided as part of the notification process. In this embodiment, one or more notifications may include references to audience-appropriate and/or location-specific products and services. For example, if the age-group of one or both users is over 21, the sponsorship references may include advertising for an alcoholic beverage sold by the sponsor.

Other features and advantages of the invention will be apparent to those of skill in the art upon reading the following description, in conjunction with the included drawing figures described below.

### BRIEF DESCRIPTION OF THE DRAWINGS

FIG. 1 is a schematic illustration of a cellular phone architecture usable with an implementation of the invention;

FIG. 2 is a network diagram of a communications architecture usable with an implementation of the invention;

FIG. 3 is a network diagram of a communications architecture usable with an implementation of the invention;

FIG. 4 is a network diagram of a communications architecture usable with an implementation of the invention; and

FIG. 5 is a flow chart illustrating a process of providing a matchmaking service to a user of a mobile device according to an embodiment of the invention.

While the invention is susceptible to various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION

Before describing the disclosed implementations in detail, a brief description of a number of suitable computing and communications architectures will be undertaken to aid the reader. As device-implemented steps are described herein, it will be appreciated that such steps are executed at the device via computerized execution of computer-readable instructions. Such instructions are read by the device, i.e., by a processor resident in the device, from a computer-readable medium such as a RAM, ROM, disc, flash drive, etc. As used in the attached claims, unless otherwise indicated, the phrase “computer” indicates any computing device having an electronic processor therein or accessible thereto, and the phrase “computer-readable medium/media” includes such media as are human tangible, i.e., excluding nontangible media such as RF signals and acoustic signals. “Computer-executable instructions” include any suitable code form such as object code, machine code, or other computer-executable form.

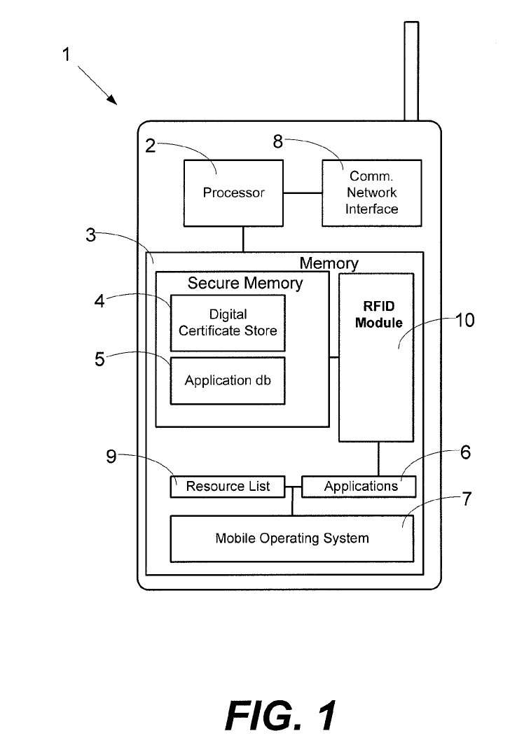

Referring now to FIG. 1, this figure is a schematic illustration of a device architecture usable in accordance with an embodiment of the invention. The illustrated device 1 is a cellular phone (“cell phone”), but it will be appreciated that the principles described herein are applicable to any device having the necessary computational and computing resources. The illustrated cell phone 1 includes a processor 2 for controlling the operation of the phone 1. The processor 2 operates in conjunction with memory 3, which is used for the storage of instructions (e.g., digital certificates 4, applications 5 etc.) as well as for ongoing operations (e.g., related to operating system 6 or running applications 7). The processor 2 also controls and communicates with a communications network interface 8, which is responsible for executing communication tasks, e.g., sending and receiving information over the cellular network or via a local protocol such as Bluetooth. The phone 1 may also include numerous other elements such as a resource list 9 and RFID functionality 10.

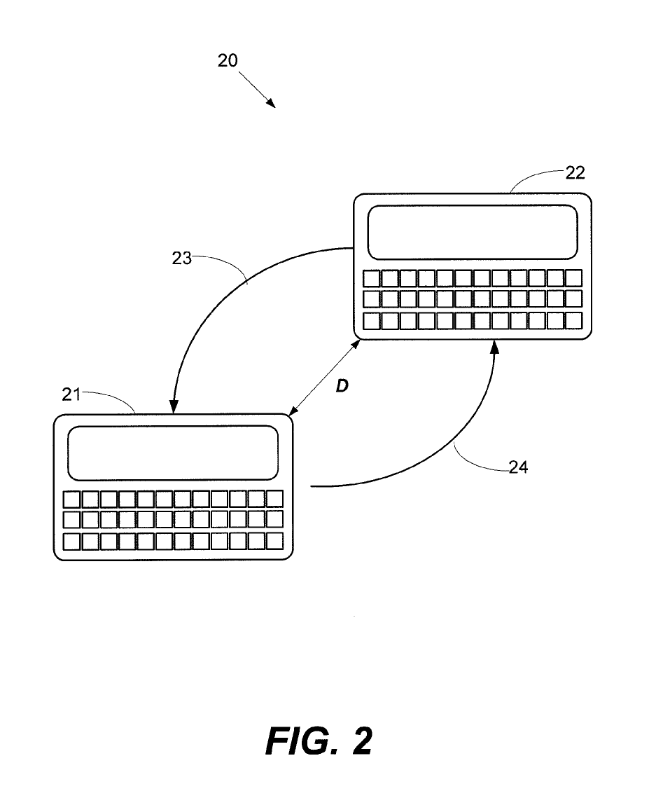

Turning now to FIG. 2, one possible communications architecture is shown. The illustrated architecture 20 includes a first cellular device 21 and a second cellular device 22. Each device has both near-field (e.g., Bluetooth) and far-field (i.e., cellular) capability. In the illustrated communications architecture the phones 21, 22 are in near-field communication with each other, as may be the case during discovery of potential matches and notification of potential matches, as will be discussed in greater detail below.

The distance D between the phones 21, 22 will determine whether or not near-field communications are possible. In an embodiment of the invention, the ability to execute such communications is used as an indication of proximity, i.e., if another device is near enough to allow Bluetooth communications, then it is considered proximal and the criteria check is executed. Bidirectional communications are shown via the first channel 23 and the second channel 24, which may be different frequencies, different packet chains, etc., as will be appreciated by those of skill in the art.

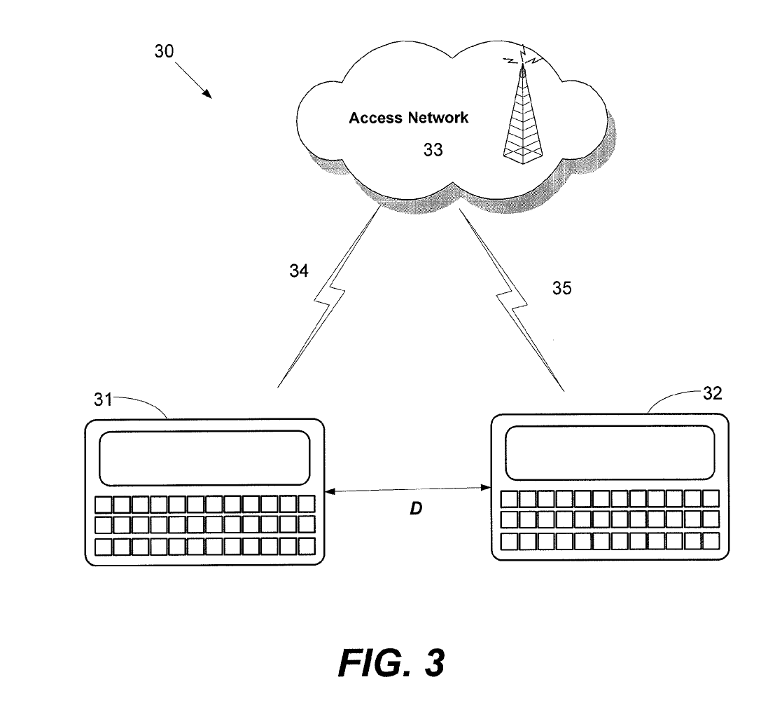

FIG. 3 shows another communications architecture 30 usable within an embodiment of the invention. The architecture 30 of FIG. 3 employs far-field, e.g., cellular, communications instead of near-field communications. In particular, each device 31, 32, communicates with an access network 33 via CDMA, GSM, or other suitable protocol, via channels 34 and 35. In this embodiment, a portion of the novel system resides at a server, call center, or other entity on the access network, e.g., to store a first user's identification and location information so that subsequent users may be identified as proximal or otherwise. The step of checking subsequent users against the first user's match criteria may be executed on the same network entity or, as in FIG. 2, on the user device itself.

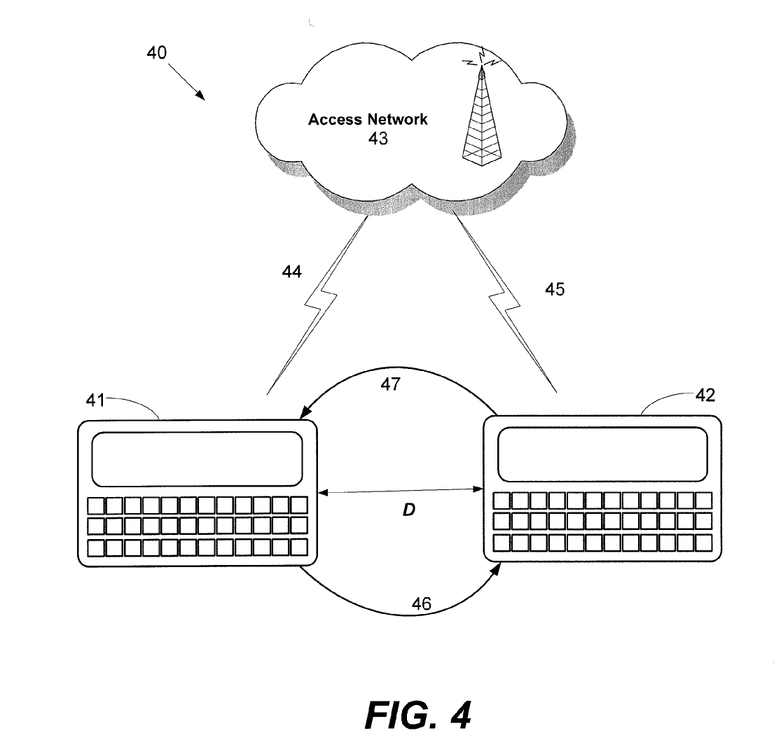

Turning to FIG. 4, yet another architecture embodiment is shown. In particular, the system 40 of FIG. 4 includes a bidirectional cellular link and a bidirectional near-field link. The cellular link includes channels 44 and 45 as well as elements of the access network 43, while the near-field link includes short range channels 46 and 47. As discussed above, cellular (44, 45) and short range (46, 47) channels may use any suitable protocol or multiplexing technique as will be understood by those of skill in the art. In one potential embodiment of the invention, the cellular channels 44, 45 are CDMA channels, and the short-range channels 46, 47 include one or more Bluetooth links.

In the architecture illustrated in FIG. 4, the system may use short-range connectivity or location as conveyed through the access network 43 to determine whether a first and second device (and hence first and second users) are in proximity to one another. The illustrated architecture 40 is most useful for devices that have limited available processing power or storage capability. Using this architecture, computationally intensive activities, such as scanning and comparing, may be off-loaded from the mobile device to the access network 43, with the short-range communications channels 46, 47 being used only once a potential match, i.e., a proximate user meeting the preset criteria, has been identified.

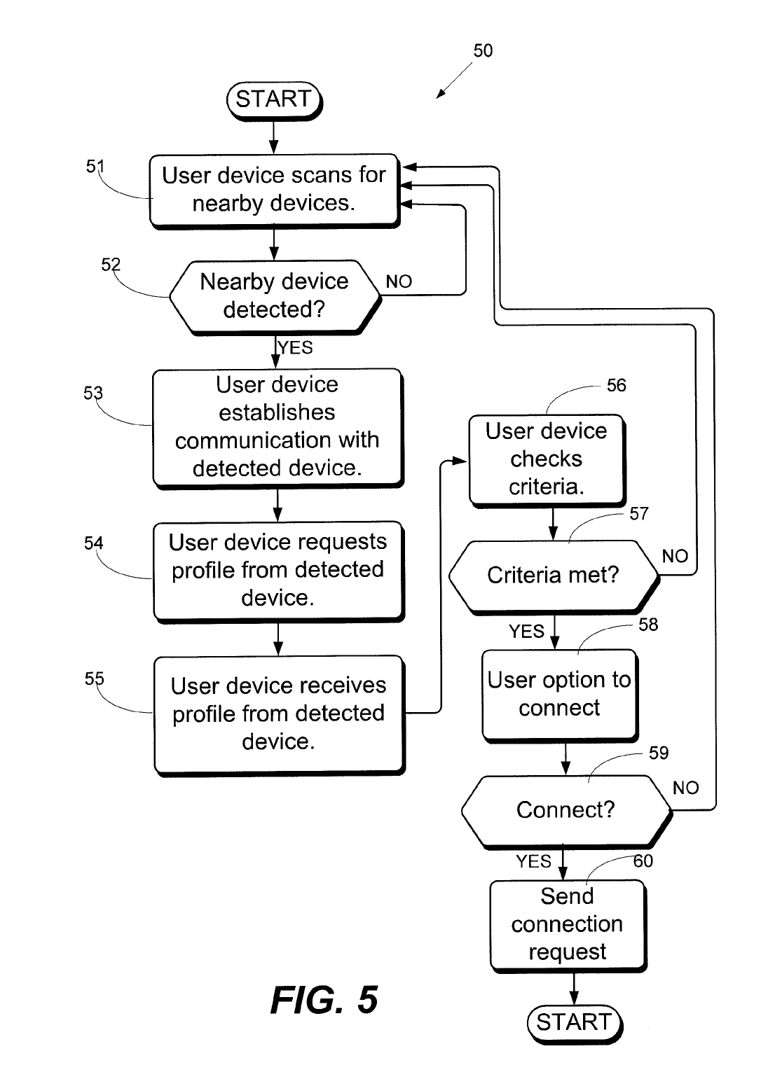

Given the various architectures within which the invention may be implemented, it will be appreciated that the sequence, location, and extent of computational operations will vary. However, an exemplary match-making process is illustrated by way of the flow chart 50 in FIG. 5. At the outset of the process 50, the mobile device for a user of interest is waiting to detect a proximal other user. In the illustrated embodiment, this is accomplished by periodically scanning for signals from other nearby devices, e.g., Bluetooth communication devices. By way of background, Bluetooth allows devices to communicate wirelessly at 2.4 gigahertz with a rate of 720 kbps within a range of 10 to 100 meters. The Bluetooth RF transceiver is found at the physical layer of the seven-layer networking model. Bluetooth supports 79 channels spaced 1 MHz apart using spread spectrum technology. To support Bluetooth communications, each device of interest should include a built-in or added Bluetooth adapter. It will be appreciated that Bluetooth itself and the manner of implementing Bluetooth described herein are just examples, and that other technologies including or excluding Bluetooth technology may be used to implement the described principles. One example of such technologies is the IEEE 802.11x family of standards.

Continuing with the description of the process 50, when a nearby device is detected in stage 52 after scanning at stage 51, the process 50 flows to stage 53, wherein the user device establishes communication with the detected device. In particular, within the Bluetooth protocol, when devices come into each other's radio range, the link management protocol (LMP) executes peer-to-peer message exchange, performing link setup and negotiation of packet size, including segmentation and reassembly of packets, if needed.

Having established a connection with the other device, the user device of interest requests the other user's profile information in stage 54. It will be appreciated that at this stage of the process 50, it will be important that each device host a similar application, i.e., one that understands the profile request and can convey the profile information. At stage 55, the user device of interest receives the profile information from the other device. Although stages 54 and 55 have been described as a “pull” process, it will be appreciated that a “push” process may instead be used.

At stage 56, the user device compares the received profile information with its own criteria. If a match is determined at stage 57, the process flows to stage 58, wherein the user device is given an option to initiate a connection with the other user. If the user of interest elects at stage 59 to connect with the other user, then a request is sent to the device of the other user at stage 60. Otherwise, the process returns to stage 51 to scan for devices associated with other users.

When the device of the detected user receives the connection request as described in stage 60, a counterpart process then occurs. In particular, the other user is then given the opportunity to view information relating to the first user and may decide to accept or reject the connection request from the first user. If the request is accepted, the users are placed into direct electronic communication, and may either have a substantive conversation electronically or may simply agree on a meeting location to physically meet one another and have a face-to-face conversation. The electronic connection established between the users' devices may take any suitable form, but in an embodiment of the invention, an ad hoc piconet is used to facilitate the connection.

Having discussed the principles of the invention, certain additional and alternative features will be discussed. Although the foregoing examples related primarily to romantic pairing of individuals, it will be appreciated that the same principles may be applied to match individuals for business networking or other purposes, and indeed, such is a purpose of the invention in alternative embodiments. It will be appreciated that the match criteria may or may not differ depending upon the use to which the system is put. For example, when used for romantic pairing, the match criteria may include height, weight, eye color, hair color, etc. In contrast, when used for business networking purposes, the criteria may include job title, professional associations, etc. A user's profile may contain all usable criteria, and designate subsets for different types of pairing. For example, occupation data may be relevant for both romantic and business matching, but hair color would likely only be relevant to romantic matching.

Although not required, user location information is provided via GPS in an embodiment of the invention. Many cell phones and other handheld communications devices are equipped with GPS functionality in order to provide navigation services etc., and the invention is able to leverage this in-place functionality to detect proximity. Alternatively, the availability of near-field connectivity serves as an indicator of proximity as discussed above.

In an embodiment of the invention, a user profile on a given mobile device is comprised of two portions, namely a user-descriptive portion and a match-descriptive portion. The user-descriptive portion of the user profile is utilized by the system to convey information about the user to another proximal user so that that other proximal user's communication device may assess the potential for a match. The match-descriptive portion of the user profile contains criteria used to evaluate potential matches. Such criteria may include, for example, age, interests, religion, education level, income range, interest in parenting, and other personal attributes and inclinations.

In an embodiment of the invention, certain characteristics may be weighted more heavily than others. For example, a male user may require that potential matches be female, and may prefer but not require a certain religion or occupation.

With respect to the user option to connect to a match, the user may receive a real-time electronic notification via the GUI (graphical user interface) of the device or via another medium such as e-mail, text message or similar medium, that another user or users meeting their criteria are nearby. With the notification, the user may also receive the profile information of the other user to decide whether an immediate face-to-face meeting is desired. If so, notification is sent to the other user to facilitate an immediate meeting.

In a further embodiment of the invention, third-party sponsorship opportunities are provided as part of the notification process. In this embodiment, one or more notifications may include references to audience-appropriate and/or location-specific products and services. For example, if the age-group of one or both users in over 21, the sponsorship references may include advertising for an alcoholic beverage sold by the sponsor. If the user location is a grocery store, the sponsorship references may include advertising for a sale on produce. In an implementation of this embodiment, the system uses known navigation software techniques to identify a particular geographical location as corresponding to a particular venue.

With respect to the various user profiles used by the system, it will be appreciated that any suitable manner of entry may be used to create such profiles. For example, a profile may be wirelessly downloaded to a device after creation on a PC, or may be entered manually directly on the device. In either case, a dedicated application may be used for entry and retrieval of the profile, although such is not required.

It will be appreciated that the foregoing description provides examples of the disclosed system and process. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method for providing a matching service for a user of a mobile device, the method comprising:
scanning a particular region encompassing a first mobile device for the presence of short-range wireless signals from a second mobile device;
upon the detection at the first mobile device of short-range wireless signals from the second mobile device, requesting a user profile from the second device;
receiving the requested user profile at the first mobile device and comparing one or more elements of the received profile to one or more criteria associated with the user of the first mobile device;
if the one or more criteria from the received profile match the one or more criteria associated with the user of the first mobile device, presenting the user of the first mobile device an option to connect to the second mobile device; and
receiving at the first mobile device a user election to connect to one of the second mobile device and a user of the second mobile device.

2. The method according to claim 1, further comprising sending a connection request from the first device to the second device.

3. The method according to claim 2, wherein the connection request from the first device to the second device includes a user profile associated with the user of the first device.

4. The method according to claim 2, further comprising receiving at the first device from the second device an acceptance of the connection request.

5. The method according to claim 1, wherein the short-range wireless signals have a range, and wherein the size of the particular region encompassing the first mobile device is defined by the range of the short-range wireless signals.

6. The method according to claim 1, wherein the first mobile device has a GPS-defined geographical position associated with it, and wherein the extent of the particular region encompassing the first mobile device is defined with reference to the GPS-defined geographical position.

7. The method according to claim 1, wherein the user profile from the second device is user-created.

8. The method according to claim 1, further comprising presenting an advertising message on one or both of the first and second mobile devices.

9. The method according to claim 8, wherein each advertising message is selected based on the location of the mobile device on which the message is to be presented.

10. A method for providing a matching service for a user of a mobile device, the method comprising:
executing a query at a first mobile device to query a remote resource for an identification of a second mobile device within a predefined region encompassing the first mobile device;
receiving a notification at the first mobile device that the second mobile device is within the predefined region encompassing the first mobile device;
in response to receipt of the notification, retrieving at the first mobile device from the remote resource a user profile associated with a user of the second mobile device;
comparing one or more elements of the received profile to one or more criteria associated with the user of the first mobile device;
if the one or more criteria from the received profile match the one or more criteria associated with the user of the first mobile device, presenting the user of the first mobile device an option to connect to the second mobile device; and
receiving at the first mobile device a user election to connect to one of the second mobile device and a user of the second mobile device.

11. The method according to claim 10, further comprising sending a connection request from the first device to the second device via the remote resource.

12. The method according to claim 10, wherein the remote resource includes a cellular network.

13. The method according to claim 11, wherein the connection request from the first device to the second device includes a user profile associated with the user of the first device.

14. The method according to claim 2, further comprising receiving at the first device from the second device via the remote resource an acceptance of the connection request.

15. The method according to claim 10, wherein the first mobile device has a GPS-defined geographical position associated with it, and wherein the extent of the predefined region encompassing the first mobile device is defined with reference to the GPS-defined geographical position.

16. The method according to claim 10, wherein the user profile from the second device is user-created.

17. A method for providing a matching service for a user of a mobile device, the method comprising:
executing a query at a first mobile device to query a remote resource for an identification of a second mobile device within a predefined region encompassing the first mobile device;
receiving a notification at the first mobile device that the second mobile device is within the predefined region encompassing the first mobile device and that a user associated with the second mobile device matches a predefined subset of criteria associated with a user of the first mobile device;
presenting the user of the first mobile device with an option to connect to the second mobile device; and
receiving at the first mobile device a user election to connect to one of the second mobile device and a user of the second mobile device.

18. The method according to claim 17, wherein the remote resource includes a cellular network.

19. The method according to claim 17, further comprising sending a connection request from the first device to the second device via a short-range wireless protocol.

20. The method according to claim 18, wherein the connection request from the first device to the second device includes a user profile associated with the user of the first device.
